(19) United States
(12) Patent Application Publication
(10) Pub. No.: US 2023/0143394 A1
(43) Pub. Date: May 11, 2023

(54) INSULATION PASTE FOR LITHIUM ION SECONDARY BATTERY CURRENT COLLECTOR AND METHOD FOR PRODUCING INSULATION LAYER

(71) Applicant: KANSAI PAINT CO., LTD., Hyogo (JP)

(72) Inventors: Hiroe HOMMA, Aichi (JP); Masashi TATSUKAWA, Kanagawa (JP); Yoshiyuki YUKAWA, Aichi (JP)

(73) Assignee: KANSAI PAINT CO., LTD., Hyogo (JP)

(21) Appl. No.: 17/912,602

(22) PCT Filed: Mar. 17, 2021
(86) PCT No.: PCT/JP2021/010822

§ 371 Date: Sep. 19, 2022

(30) Foreign Application Priority Data
Mar. 23, 2020 (JP) 2020-051173
Apr. 24, 2020 (JP) 2020-077072
Mar. 12, 2021 (JP) 2021-040284

(51) Int. Cl. H01M 10/658; H01M 10/0525; H01M 4/66

(52) U.S. Cl. CPC H01M 10/658; H01M 10/0525; H01M 4/662

(57) ABSTRACT

An insulation paste for a current collector for a lithium-ion secondary battery contains an inorganic filler (A), a binder (B), a dispersion resin (C), and a solvent (D), wherein the insulation paste has a viscosity (shear rate of 1 s⁻¹) of 2000 mPa·s or more, and has a TI value of greater than 1, and the TI value is a ratio of the viscosity at a shear rate of 1 s⁻¹ to the viscosity at a shear rate of 1000 s⁻¹.

### TECHNICAL FIELD

The present invention relates to an insulation paste applied to a current collector of the positive electrode and/or the negative electrode of lithium ion secondary batteries, and a method for producing an insulation layer formed by applying the paste.

### BACKGROUND ART

Some lithium-ion secondary batteries are formed of a laminate of positive and negative electrodes, or formed of wound positive and negative electrodes. These positive and negative electrodes are manufactured by applying a mixture layer to both sides of metal foil (current collector), and drying and pressing the foil. Many positive and negative electrodes have an exposed portion at the end of the metal foil as a current path. A technique for preventing or insulating the exposed portion from a short circuit is known.

For example, PTL 1 discloses a lithium-ion secondary battery containing an insulation layer. Although this insulation layer prevents the positive plate and negative plate from a short circuit, the coating agent forming the insulation layer has poor storage stability or coating workability, and may result in insufficient appearance. Additionally, a physical load applied during pressing may cause the insulation layer to fall off and may thus decrease the stability of insulation properties.

In particular, a high load (bending, cutting, pressurization, scratching, etc.) applied in a production step such as pressing may cause the insulation layer to be removed or come off from the current collector, making the insulation layer unable to provide its original performance. Thus, adhesiveness between the current collector and the insulation layer is very important because of its significant impact on battery performance and safety.

### CITATION LIST

### Patent Literature

PTL 1: JP2013-232425A

### SUMMARY OF INVENTION

### Technical Problem

An object achieved by the present invention is to provide an insulation paste excellent in storability (pigment sedimentation, viscosity), dispersibility, and coating workability, and an insulation layer excellent in post-coating appearance and adhesion to current collectors.

### Solution to Problem

The present inventors conducted extensive research to achieve the object and found that the object can be achieved by an insulation paste for current collectors for lithium-ion secondary batteries containing an inorganic filler (A), a binder (B), a dispersion resin (C), and a solvent (D), wherein the insulation paste has a viscosity at a shear rate of 1 s⁻¹ of 1500 mPa·s or more, and has a TI value of greater than 1, the TI value being a ratio of the viscosity at a shear rate of 1 s⁻¹ to the viscosity at a shear rate of 1000 s⁻¹. The inventors then completed the present invention.

Specifically, the present invention provides the following insulation paste and insulation layer.

### Item 1.

An insulation paste for a current collector for a lithium-ion secondary battery, comprising

an inorganic filler (A),

a binder (B),

a dispersion resin (C), and

a solvent (D),

wherein the insulation paste has a viscosity (shear rate of 1 s⁻¹) of 1500 mPa·s or more, and has a TI value of greater than 1, the TI value being a ratio of the viscosity at a shear rate of 1 s⁻¹ to the viscosity at a shear rate of 1000 s⁻¹.

### Item 2.

The insulation paste for a current collector for a lithium-ion secondary battery according to Item 1, wherein an insulation layer obtained by applying the insulation paste to a current collector has an adhesive force of 2.5 N/m or more.

### Item 3.

The insulation paste for a current collector for a lithium-ion secondary battery according to Item 1 or 2, wherein the inorganic filler (A) has a volume average particle size (D50) of 0.5 to 7 μm, and has a standard deviation of particle size distribution of 1.4 μm or less.

### Item 4.

The insulation paste for a current collector for a lithium-ion secondary battery according to any one of Items 1 to 3, wherein the dispersion resin (C) contains an acrylic resin having a polar group.

### Item 5.

The insulation paste for a current collector for a lithium-ion secondary battery according to Item 4, wherein the polar group of the acrylic resin having a polar group comprises a phosphate group.

### Item 6.

The insulation paste for a current collector for a lithium-ion secondary battery according to Item 4 or 5, wherein the acrylic resin having a polar group contains as a constituent a dispersion resin having a hydrocarbon group that has four or more carbon atoms (c2).

### Item 7.

The insulation paste for a current collector for a lithium-ion secondary battery according to any one of Items 4 to 6, wherein the acrylic resin having a polar group has a weight average molecular weight within the range of 1,000 to 100,000.

### Item 8.

The insulation paste for a current collector for a lithium-ion secondary battery according to Item 1,

wherein

the dispersion resin (C) comprises an acrylic resin having a polar group (c) which is a copolymer of starting material monomers containing
a polymerizable unsaturated monomer having a polar functional group (c1), and
a polymerizable unsaturated monomer having a hydrocarbon group that has four or more carbon atoms (c2), and
   the copolymer has a weight average molecular weight of 1,000 to 100,000.

### Item 9.

The insulation paste for a current collector for a lithium-ion secondary battery according to any one of Items 1 to 8, wherein the inorganic filler (A) contains at least one member selected from the group consisting of alumina, silica, TiO₂, BaTiO₃, ZrO₂, boehmite, zeolite, apatite, and kaolin.

### Item 10.

The insulation paste for a current collector for a lithium-ion secondary battery according to any one of Items 1 to 9, wherein the binder (B) contains a modified or unmodified polyvinylidene fluoride.

### Item 11.

The insulation paste for a current collector for a lithium-ion secondary battery according to any one of Items 1 to 10, wherein the solvent (D) contains N-methyl-2-pyrrolidone.

### Item 12.

The insulation paste for a current collector for a lithium-ion secondary battery according to any one of Items 1 to 11, comprising substantially no active substance for an electrode.

### Item 13.

A method for producing an insulation layer for a current collector for a lithium-ion secondary battery, comprising applying the insulation paste of any one of Items 1 to 12 to partially or entirely to a current collector, and subsequently drying the paste by heating to form an insulation layer.

### Item 14.

The method for producing an insulation layer for a current collector for a lithium-ion secondary battery according to Item 13, wherein the insulation layer is non-porous.

The method for producing an insulation layer for a current collector for a lithium-ion secondary battery according to Item 13 or 14, wherein the current collector contains aluminum or a composite metal containing aluminum.

### Advantageous Effects of Invention

The insulation paste according to the present invention is excellent in storability (pigment sedimentation, viscosity), dispersibility, and coating workability, and an obtained insulation layer has excellent appearance and adhesion.

### DESCRIPTION OF EMBODIMENTS

The following describes the present invention in detail.

In the present specification, the phrase “starting material monomer(s) of a resin contains monomer X” means that the resin is a (co)polymer of one or more starting material monomers containing the monomer X unless indicated otherwise. In the present specification, the (co)polymer refers to a polymer or a copolymer.

In the present specification, the term “(meth)acrylate” refers to acrylate and/or methacrylate, and the term “(meth)acrylic acid” refers to acrylic acid and/or methacrylic acid. The term “(meth)acryloyl” refers to acryloyl and/or methacryloyl. The term “(meth)acrylamide” refers to acrylamide and/or methacrylamide.

In the present specification, the “insulation layer” may also be referred to as “insulation film,” “coating film,” or “film.”

### Insulation Paste

The insulation paste for current collectors for lithium-ion secondary batteries according to the present invention contains an inorganic filler (A), a binder (B), a dispersion resin (C), and a solvent (D).

From the standpoint of storability and appearance, the insulation paste has a viscosity at a shear rate of 1 s⁻¹ of typically 1500 mPa·s or more, preferably 1800 mPa·s or more, more preferably 2000 mPa·s or more, more preferably 2000 to 7000 mPa·s, and still more preferably 2500 to 5000 mPa·s. A viscosity at a shear rate of 1 s⁻¹ of less than 1500 mPa·s may result in poor storability (pigment sedimentation), appearance, or sagging. A viscosity at a shear rate of 1 s⁻¹ of 7000 mPa·s or less leads to excellent coating workability and appearance.

The TI value, which is a ratio of the viscosity at a shear rate of 1 s⁻¹ to the viscosity at a shear rate of 1000 s⁻¹, is typically greater than 1, and is preferably 2 to 10, more preferably 3 to 6. For example, a TI value of greater than 1 leads to excellent flowability (coating workability) due to a decreased viscosity during coating (at a shear rate of about 1000 s⁻¹), and also leads to an increased viscosity of the insulation layer (coating film) after coating (at a shear rate of about 1 s⁻¹), which prevents the flow of the insulation layer, thereby giving excellent appearance.

The viscosity can be measured with, for example, a Mars 2 cone and plate viscometer (trade name, produced by HAAKE).

From the standpoint of storability (prevention of a decrease in viscosity of the insulation paste during storage, “the decrease in viscosity during storage” below), the sodium content in the insulation paste is adjusted to typically 450 ppm or less, preferably 10 to 350 ppm, more preferably 10 to 300 ppm, and still more preferably 10 to 200 ppm. A sodium content exceeding 450 ppm may lead to a decrease in viscosity during storage at high temperatures, and may result in poor pigment sedimentation or appearance (including sagging). The insulation paste may also contain sodium ions brought from various starting materials (in particular, inorganic filler described later) or from the production process, and it is not economical to completely remove sodium ions.

The details of the cause of the decrease in viscosity during storage is unknown. It is speculated that, for example, interaction due to hydrogen bonds between the components (i.e., the inorganic filler (A), binder (B), and dispersion resin (C)) typically maintains the viscosity of the paste, but sodium ions in a predetermined amount or more gradually cleave the bonds, decreasing the viscosity of the insulation paste.

The sodium content in the insulation paste can be measured, for example, with an ICP emission spectrophotometer. Specifically, a sample (insulation paste) is dissolved in a mixture solution of nitric acid and sulfuric acid (mixing ratio: 1/1), and measured with an ICP emission spectrophotometer (Shimadzu Corporation, ICPS-8100).

### Inorganic Filler (A)

The inorganic filler (A) for use in the insulation paste according to the present invention can be any inorganic filler that is non-conductive. Examples include alumina, silica, TiO₂, BaTiO₃, ZrO₂, boehmite, zeolite, apatite, and kaolin. These can be used singly or in a combination of two or more. In particular, alumina and/or boehmite is preferable, and boehmite is more preferable. Alumina is aluminum oxide represented by Al₂O₃, and boehmite is alumina monohydrate represented by the composition γ-AlO(OH).

The inorganic filler (A) in the insulation paste according to the present invention preferably has a volume average particle size of 0.5 to 7 μm.

The inorganic filler (A) in the insulation paste according to the present invention has a volume average particle size (D50) of preferably 0.5 to 7 μm, more preferably 0.8 to 5.5 μm, and still more preferably 1.2 to 3.5 μm.

A small particle size increases the surface area of particles and thus increases paste viscosity, resulting in poor coating workability or appearance, whereas a large particle size results in poor surface appearance of the insulation layer.

Although the details are unknown, an inorganic filler with a predetermined particle size or more is considered to increase the cohesion of the insulation layer to the current collector, thereby increasing adhesive force. The particle size distribution is preferably as narrow as possible. The standard deviation of particle size distribution is preferably 1.4 μm or less, and more preferably 1.0 μm or less. In the present invention, the volume average particle size (D50) and standard deviation of particle size distribution of the inorganic filler present in the insulation paste are determined by measuring the insulation paste with a particle size distribution analyzer (trade name: Microtrac MT3000, produced by MicrotracBEL Corp.).

The volume average particle size (D50) of the inorganic filler (A) itself, which is a primary particle size, is preferably 0.01 to 6 μm, more preferably 0.1 to 5 μm, and still more preferably 0.7 to 3.0 μm.

The shape can be, for example, spherical, elliptical, plate-shaped, cubical, flakey, needle-shaped, or rod-shaped; and any of these shapes can be suitably used. The aspect ratio is preferably 1.1 or more.

When boehmite is used for the inorganic filler (A), care must be taken particularly for the sodium content in the insulation paste. Because sodium hydroxide is typically used in the production process of aluminum hydroxide, which is the starting material of boehmite, boehmite also contains a predetermined amount or more of sodium ions. Although sodium ions can be removed, for example, by washing, it is difficult to completely remove them from an economical perspective.

Specifically, in a preferred embodiment, the sodium content in boehmite is typically 2000 ppm or less, preferably 40 to 1500 ppm, and more preferably 200 to 1200 ppm based on the solids content of boehmite.

### Binder (B)

The binder (B) for use in the insulation paste according to the present invention is a copolymer produced from a monomer containing a polymerizable unsaturated group represented by the following formula (1) as a constituent and can be synthesized by copolymerizing a monomer that contains the monomer containing a polymerizable unsaturated group.

(R₁—)(R₂—)C═C(—R₃)(—R₄) (1)

wherein R₁ to R₄ each independently represent an atom selected from the group consisting of hydrogen, fluorine, and chlorine, or a linear, branched, and/or cyclic organic group.

The monomer containing a polymerizable unsaturated group for use can be any monomer that has the structure of formula (1), and examples include vinyl chloride, vinylidene chloride, vinyl fluoride, vinylidene fluoride, fatty acid vinyl ester, vinyl ether, vinyl pyrrolidone, styrene, (meth)acryloyl group-containing monomers, and (meth)acrylamide group-containing monomers. These can be use singly, or in a combination of two or more.

Polymerization to obtain the monomer containing a polymerizable unsaturated group may be performed by a known polymerization method. For example, the monomer containing a polymerizable unsaturated group may be produced by performing solution polymerization on a monomer containing the monomer containing a polymerizable unsaturated group in an organic solvent. The polymerization method, however, is not limited thereto, and, for example, bulk polymerization, emulsion polymerization, suspension polymerization, or the like is also applicable. In solution polymerization, either continuous polymerization or batch polymerization may be performed. Monomers may be added all at once or in divided portions, or may be added continuously or intermittently. After polymerization, the polymer may be modified in various ways (for example, hydrolysis after polymerization, acetalization, or grafting by performing a reaction with other resins).

The polymerization initiator for use in the polymerization can be any initiator, and can be a known radical polymerization initiator such as a peroxide-based initiator, an azo-based initiator, a redox-based initiator, or an organic halide-based initiator.

The solvent for use in the polymerization can be any known solvent. The organic solvents listed in the Dispersion Resin (C) section below can be suitably used.

The polymerization reaction temperature is not particularly limited, and is typically set within the range of about 30 to 200° C.

Examples of the binder (B) includes polyvinylidene fluoride, polyvinyl alcohol, polyvinyl acetal, acrylic resin, polyvinyl acetate, polyvinyl chloride, polystyrene, polyvinyl ether, and polyvinyl pyrrolidone, and these binders can be modified with various functional groups. The functional group for use is preferably a polar functional group such as an acid group or base. These can be used singly or in a combination of two or more; in particular, from the standpoint of insulation properties and coating film strength (i.e., cohesion), modified or unmodified polyvinylidene fluoride is preferable.

The binder (B) has a weight average molecular weight of preferably more than 100,000, more preferably within the range of 110,000 to 5,000,000, and still more preferably within the range of 200,000 to 2,000,000.

### Dispersion Resin (C)

The dispersion resin (C) for use in the present invention preferably contains at least one acrylic resin. The dispersion resin (C) is a component different from the binder (B). In particular, the dispersion resin (C) preferably contains an acrylic resin having a polar group, which is a copolymer of a starting material monomer containing a polymerizable unsaturated monomer having at least one polar group.

A polar group such as an acid group in the dispersion resin (C) enhances adhesion to the substrate or dispersibility of pigments. However, an excessive amount of a polar group leads to an overly high polarity, making the appearance poor. The presence of a low-polarity monomer with four or more carbon atoms enhances compatibility with a low-polarity fluorine resin, making the appearance better. The dispersibility also somewhat improves.

Thus, the acrylic resin having a polar group (c) is more preferably a copolymer of starting material monomers containing a polymerizable unsaturated monomer having a polar functional group (c1) and a polymerizable unsaturated monomer having a hydrocarbon group that has four or more carbon atoms (c2), with the copolymer having a weight average molecular weight of 1,000 to 100,000. Because polyvinyl alcohol (PVA) has a high polarity, polyvinyl alcohol leads to appearance inferior to that of such an acrylic resin having a polar group (c).

### Acrylic Resin Having Polar Group (c)

Because of the polymerizable unsaturated monomer having a polar functional group (c1) and the polymerizable unsaturated monomer having a hydrocarbon group that has four or more carbon atoms (c2), the acrylic resin having a polar group (c) can achieve all of the dispersibility of the inorganic filler (A) in the insulation paste, compatibility of the dispersion resin (C) with the binder (B), and adhesion of the insulation layer formed from the insulation paste (coating film, insulation film) to a current collector.

### Polymerizable Unsaturated Monomer Having Polar Group (c1)

The polymerizable unsaturated monomer having a polar group (c1) for use can be any polymerizable unsaturated monomer as long as the monomer has a polar group. Examples of polar groups include a carboxyl group, a phosphate group, a sulfonic acid group, an amino group, a quaternary base, a hydroxyl group, and a polyalkylene glycol group. A single polymerizable unsaturated monomer may have multiple polar groups. From the standpoint of adhesiveness to a substrate, the polar group is preferably a phosphate group.

Specific examples of the polymerizable unsaturated monomer having a polar group include polymerizable unsaturated monomers having a carboxyl group, such as (meth)acrylic acid, maleic acid, crotonic acid, and β-carboxyethyl acrylate; polymerizable unsaturated monomers having a phosphate group, such as 2-(meth)acryloyloxyethyl acid phosphate, and 2-(meth)acryloyloxypropyl acid phosphate; polymerizable unsaturated monomers having a sulfonic acid group, such as 2-acrylamide methylpropanesulfonic acid, 2-sulfoethyl(meth)acrylate, allyl sulfonic acid, 4-styrenesulfonic acid, sodium salts of these sulfonic acids, and ammonium salts of these sulfonic acids; polymerizable unsaturated monomers having an amino group, such as N,N-dimethylaminoethyl (meth)acrylate, N,N-diethylaminoethyl (meth)acrylate, N,N-dimethylaminopropyl (meth)acrylamide, and adducts of glycidyl (meth)acrylate with amines; polymerizable unsaturated monomers having a quaternary base, such as 2-(methacryloyloxy) ethyl trimethylammonium chloride; polymerizable unsaturated monomers having a hydroxyl group, such as monoesterified products of (meth)acrylic acids with dihydric alcohols having 2 to 8 carbon atoms (such as 2-hydroxyethyl (meth)acrylate, 2-hydroxypropyl (meth)acrylate, 3-hydroxypropyl (meth)acrylate, and 4-hydroxybutyl (meth)acrylate), ε-caprolactone-modified compounds of these monoesterified products of (meth)acrylic acids with dihydric alcohols having 2 to 8 carbon atoms, N-hydroxymethyl (meth)acrylamide, allyl alcohol, and (meth)acrylates having hydroxy-terminated polyoxyalkylene chains; and polymerizable unsaturated monomers having a polyalkylene glycol group, such as polyethylene glycol (meth)acrylate, and polypropylene glycol (meth)acrylate. Of these, the polymerizable unsaturated monomer having a polar group (c1) is preferably a polymerizable unsaturated monomer having an acid group, and more preferably a polymerizable unsaturated monomer having a phosphate group. These can be used singly, or in a combination of two or more.

The starting material monomer preferably contains the polymerizable unsaturated monomer having a polar group (c1) in an amount of 1 to 80 mass %, more preferably 5 to 70 mass %, and still more preferably 20 to 60 mass %.

A content of the polymerizable unsaturated monomer having a polar group (c1) in the starting material monomer within these ranges results in excellence in compatibility with the binder, pigment dispersibility, and adhesion.

If the acrylic resin having a polar group (c) contains an acid group, the acid value is preferably 200 mgKOH/g or lower, and more preferably falls within the range of 5 to 150 mgKOH/g. If the acrylic resin having a polar group (c) contains an amino group, the amine value is preferably 200 mgKOH/g or lower, and more preferably falls within the range of 5 to 150 mgKOH/g. If the acrylic resin having a polar group (c) contains a hydroxyl group, the hydroxyl value is preferably 200 mgKOH/g or lower, and more preferably falls within the range of 5 to 150 mgKOH/g.

The acid value of the acrylic resin having a polar group (c) can be measured in accordance with JIS K-5601-2-1(1999). The amine value of the acrylic resin having a polar group (c) can be measured in accordance with JIS K 7237(1995).

### Polymerizable Unsaturated Monomer Having Alkyl Group That Has Four or More Carbon Atoms (c2)

From the standpoint of compatibility with the binder (B), the starting material monomer of the acrylic resin having a polar group (c) preferably contains a polymerizable unsaturated monomer having an alkyl group that has four or more carbon atoms (c2). In particular, if the binder (B) is a polyvinylidene fluoride with relatively low polarity, a polymerizable unsaturated monomer having an alkyl group that has four or more carbon atoms (c2) can be preferably used. The polymerizable unsaturated monomer having an alkyl group that has four or more carbon atoms (c2) is a monomer different from the polymerizable unsaturated monomer having a polar group (c1) in the starting material monomer, and preferably contains no polar group.

The polymerizable unsaturated monomer having an alkyl group that has four or more carbon atoms (c2) can be any polymerizable unsaturated monomer having a linear, branched, or cyclic alkyl group, as long as the monomer is a polymerizable unsaturated monomer having an alkyl group that has four or more carbon atoms. Specific examples include (meth)acrylate having a linear, branched, or cyclic alkyl group, such as styrene, naphthyl (meth)acrylate, n-butyl (meth)acrylate, isobutyl (meth)acrylate, t-butyl (meth)acrylate, 2-ethylhexyl (meth)acrylate, n-octyl (meth)acrylate, lauryl (meth)acrylate, stearyl (meth)acrylate, isostearyl acrylate, cyclohexyl (meth)acrylate, isobornyl (meth)acrylate, and tridecyl (meth)acrylate. These can be used singly, or in a combination of two or more.

The polymerizable unsaturated monomer having an alkyl group that has four or more carbon atoms (c2) preferably has 4 or more and 24 or fewer carbon atoms, more preferably 8 or more and 20 or fewer carbon atoms, and particularly preferably 10 or more and 17 or fewer carbon atoms. The polymerizable unsaturated monomer having an alkyl group that has four or more carbon atoms (c2) preferably has the structure of a polymerizable unsaturated monomer having a linear or branched alkyl group.

The starting material monomer preferably contains the polymerizable unsaturated monomer having an alkyl group that has four or more carbon atoms (c2) in an amount of 1 to 95 mass %, more preferably 10 to 80 mass %, and more preferably 20 to 60 mass %.

A content of the polymerizable unsaturated monomer having an alkyl group that has four or more carbon atoms in the starting material monomer within these ranges leads to excellent dispersibility and storability.

### Other Polymerizable Unsaturated Monomer

The starting material monomer for use in obtaining the acrylic resin having a polar group (c) can also be a polymerizable unsaturated monomer, other than the polymerizable unsaturated monomer having a polar group (c1) and the polymerizable unsaturated monomer having an alkyl group that has four or more carbon atoms (c2). Examples of such polymerizable unsaturated monomers other than the polymerizable unsaturated monomers (c1) and (c2) include polymerizable unsaturated monomers having an alkyl group that has three or fewer carbon atoms, such as methyl (meth)acrylate, ethyl (meth)acrylate, n-propyl (meth)acrylate, and isopropyl (meth)acrylate; and polymerizable unsaturated monomers having two or more polymerizable unsaturated groups per molecule.

The polymerization method for the acrylic resin having a polar group (c) may be a known method. Examples include, but are not limited to, solution polymerization of the polymerizable unsaturated monomers (starting material monomer) in an organic solvent. Polymerization may be, for example, bulk polymerization, emulsion polymerization, or suspension polymerization. Solution polymerization may be continuous polymerization or batch polymerization; and the polymerizable unsaturated monomers may be added all at once, or in divided portions, or may be added continuously or intermittently.

The radical polymerization initiator for use in polymerization can be a known polymerization initiator. Examples of radical polymerization initiators for use in polymerization include cyclohexanone peroxide, 3,3,5-trimethylcyclohexanone peroxide, methylcyclohexanone peroxide, 1,1-bis(t-butylperoxy)-3,3,5-trimethylcyclohexane, 1,1-bis(t-butylperoxy)cyclohexane, n-butyl-4,4-bis(t-butylperoxy)valerate, cumenehydro peroxide, 2,5-dimethylhexane-2,5-dihydroperoxide, 1,3-bis(t-butylperoxy-m-isopropyl)benzene, 2,5-dimethyl-2,5-di(t-butylperoxy)hexane, diisopropylbenzene peroxide, t-butylcumyl peroxide, decanoyl peroxide, lauroyl peroxide, benzoyl peroxide, 2,4-dichlorobenzoyl peroxide, di-t-amyl peroxide, bis(t-butylcyclohexyl) peroxydicarbonate, t-butylperoxy benzoate, 2,5-dimethyl-2,5-di(benzoylperoxy)hexane, t-butyl peroxy ethylhexanoate, and like peroxide-based polymerization initiators; and 2,2′-azobis(isobutyronitrile), 1,1-azobis(cyclohexane-1-carbonitrile), azocumene, 2,2′-azobis(2-methylbutyronitrile), 2,2′-azobis dimethylvaleronitrile, 4,4′-azobis(4-cyanovaleric acid), 2-(t-butylazo)-2-cyanopropane, 2,2′-azobis(2,4,4-trimethylpentane), 2,2′-azobis(2-methylpropane), dimethyl 2,2′-azobis(2-methylpropionate), and like azo-based polymerization initiators. These may be used singly, or in a combination of two or more.

The solvents for use in the above polymerization or dilution are not particularly limited; water, an organic solvent, or a mixture thereof may be used, and an organic solvent is particularly preferable for use. Examples of organic solvents include hydrocarbon-based solvents, such as n-butane, n-hexane, n-heptane, n-octane, cyclopentane, cyclohexane, and cyclobutane; aromatic solvents, such as toluene and xylene; ketone-based solvents, such as methyl isobutyl ketone; ether-based solvents, such as n-butyl ether, dioxane, ethylene glycol monomethyl ether, ethylene glycol monoethyl ether, ethylene glycol monoethyl ether, ethylene glycol monobutyl ether, and diethylene glycol; ester-based solvents, such as ethyl acetate, n-butyl acetate, isobutyl acetate, butyl butyrate, ethylene glycol monomethyl ether acetate, and butylcarbitol acetate; ketone-based solvents, such as methyl ethyl ketone, methyl isobutyl ketone, and diisobutyl ketone; alcohol-based solvents, such as ethanol, isopropanol, n-butanol, s-butanol, and isobutanol; amide-based solvents, such as Equamide (trade name, produced by Idemitsu Kosan Co., Ltd.), N,N-dimethylformamide, N,N-dimethylacetamide, N-methylformamide, N-methylacetamide, N-methylpropionamide, N-methyl-2-pyrrolidone; and other known solvents. These may be used singly, or in a combination of two or more. However, if the solvent used for polymerization and/or dilution of the acrylic resin having a polar group (c) is not removed in a solvent-removal step, the solvent would be incorporated into the insulation paste of the present invention. Thus, the solvent for use preferably satisfies the solubility parameter defined in the Solvent (D) section described below.

In solution polymerization in an organic solvent, for example, the following methods may be used: a method including mixing a polymerization initiator, polymerizable unsaturated monomer components, and a solvent, and performing heating with stirring, and a method including introducing a solvent into a reactor to prevent a rise in the temperature of the system due to the reaction heat, and adding polymerizable unsaturated monomer components and a polymerization initiator dropwise separately or in combination over a predetermined time with stirring at a temperature of 60 to 200° C. while optionally blowing an inert gas, such as nitrogen and argon.

In general, polymerization may be performed for about 1 to 10 hours. After polymerization of each step, an additional catalyst step may also be performed that comprises heating a reactor, while optionally adding a polymerization initiator dropwise.

In an embodiment, the thus-obtained acrylic resin having a polar group (c) has a weight average molecular weight (Mw) of preferably 1,000 to 100,000, more preferably 2,000 to 95,000, still more preferably 3,000 to 90,000, and particularly preferably 5,000 to 80,000. For an insulation paste for current collectors for lithium-ion secondary batteries (the adhesive force of an insulation layer obtained by applying the insulation paste to a current collector is 2.5 N/m or more), the acrylic resin having a polar group (c) has a weight average molecular weight (Mw) of preferably 1,000 to 100,000, more preferably 2,000 to 100,000, still more preferably 3,000 to 100,000, and particularly preferably 5,000 to 80,000.

The acrylic resin having a polar group (c) having a weight average molecular weight within these ranges leads to excellent dispersibility and storability.

In this specification, the weight average molecular weight is a polystyrene equivalent molecular weight that is determined from the retention time (retention volume) measured by gel permeation chromatography (GPC) based on the retention time (retention volume) of a standard polystyrene with a known molecular weight measured under the same conditions. More specifically, the measurement is performed using a gel permeation chromatography apparatus (HLC8120GPC (trade name) produced by Tosoh Corporation) together with four columns (TSKgel G-4000HXL, TSKgel G-3000HXL, TSKgel G-2500HXL, and TSKgel G-2000XL, trade names, all produced by Tosoh Corporation) under the conditions of mobile phase: tetrahydrofuran; measurement temperature: 40° C.; flow rate: 1 mL/min; and detector: RI.

### Other Resin

In the present invention, the dispersion resin (C) may optionally contain any known resin without limitation, together with the acrylic resin. Specific examples include polyester resin, epoxy resin, urethane resin, epoxy resin, polyether resin, fluorine resin, silicone resin, polycarbonate resin, melamine resin, chlorine-based resin, fluorine-based resin, cellulose-based resin, polybutadiene rubber, modified resin of these, and composite resin of these. The dispersion resin (C) may contain these resins singly or in a combination of two or more, together with the acrylic resin.

### Solvent (D)

The solvent (D) for use in the insulation paste according to the present invention can be any known solvent. Specific examples include hydrocarbon-based solvents, such as n-butane, n-hexane, n-heptane, n-octane, cyclopentane, cyclohexane, and cyclobutane; aromatic solvents, such as toluene, and xylene; ketone-based solvents, such as methyl isobutyl ketone; ether-based solvents, such as n-butyl ether, dioxane, ethylene glycol monomethyl ether, ethylene glycol monoethyl ether, ethylene glycol monoethyl ether, ethylene glycol monobutyl ether, and diethylene glycol; ester-based solvents, such as ethyl acetate, n-butyl acetate, isobutyl acetate, ethylene glycol monomethyl ether acetate, and butyl carbitol acetate; ketone-based solvents, such as methyl ethyl ketone, methyl isobutyl ketone, and diisobutyl ketone; alcohol-based solvents, such as ethanol, isopropanol, n-butanol, sec-butanol, and isobutanol; and amide-based solvents, such as Equamide (trade name, produced by Idemitsu Kosan Co., Ltd., amide-based solvent), N,N-dimethylformamide, N,N-dimethylacetamide, N-methylformamide, N-methylacetamide, N-methylpropionamide, and N-methyl-2-pyrrolidone. These solvents can be used singly, or in a combination of two or more.

Of these, from the standpoint of solubility of the dispersion resin (C) and dispersion stability of the insulation paste, the solvent (D) for use in the insulation paste according to the present invention is preferably a non-hydrocarbon-based solvent. For example, the solvent (D) preferably contains a solvent having a polar functional group such as an ester bond, a hydroxyl group, a carboxyl group, an amide bond, an amino group, an ether bond, a carbonyl group, or a lactam bond, and particularly preferably contains N-methyl-2-pyrrolidone.

From the standpoint of dispersibility of the insulation paste and prevention of the modification or hydrolysis of resin, the solvent (D) preferably contains substantially no water. The phrase “contains substantially no water” means that the water content is typically 1 mass % or less based on the entire amount of the insulation paste.

In the present invention, the water content of the insulation paste can be measured with the Karl Fischer coulometric titration method. Specifically, the water content of the insulation paste can be measured with a Karl Fischer moisture analyzer (produced by Kyoto Electronics Manufacturing Co., Ltd., product name: MKC-610), by setting the temperature of a moisture evaporator (produced by Kyoto Electronics, product name: ADP-611) provided to the Karl Fischer moisture analyzer to 130° C.

### Production of Insulation Paste

The insulation paste of the present invention may optionally contain other components such as a pigment, a resin, and additives in addition to the inorganic filler (A), binder (B), dispersion resin (C), and solvent (D). Preferably, the insulation paste of the present invention contains substantially no active substance for electrodes.

Examples of additives include neutralizers, pigment dispersants, binders, antifoaming agents, antiseptic agents, antirust agents, plasticizers, and antistatic agents.

The solids content of the inorganic filler (A) in the insulation paste is typically 5 to 40 mass %, preferably 10 to 30 mass %, and more preferably 18 to 26 mass %, for example, from the standpoint of insulation properties, coating workability, pigment sedimentation, and dispersibility.

In the present specification, the term “solids” refers to a residue excluding volatile components, and the residue may be solid or liquid at room temperature. The mass of solids can be calculated by taking the percentage of the mass of the dried residue out of the mass of the residue before drying as the solids percentage and multiplying the mass of the sample before drying by the solids percentage. Drying conditions for determining the solids content are, for example, 105° C. for 3 hours.

The solids content of the inorganic filler (A) in the insulation paste solids is typically 50 to 99 mass %, and preferably 70 to 80 mass %, for example, from the standpoint of insulation properties, coating workability, pigment sedimentation, and dispersibility.

The solids content of the binder (B) in the insulation paste is typically 2 to 10 mass %, and preferably 4 to 7 mass %, for example, from the standpoint of coating workability, and adhesion.

The solids content of the binder (B) in the insulation paste solids is typically 5 to 40 mass %, and preferably 10 to 28 mass %, for example, from the standpoint of insulation properties, coating workability, adhesion, and dispersibility.

The solids content of the dispersion resin (C) in the insulation paste is typically 0.1 to 5 mass %, and preferably 0.2 to 2 mass %, for example, from the standpoint of dispersibility, coating workability, and adhesion. The solids content of the dispersion resin (C) in the insulation paste solids is typically 0.05 to 4 mass %, and preferably 0.1 to 3.0 mass %, for example, from the standpoint of dispersibility, coating workability, and adhesion.

The ratio by mass of the solids of the solids of the inorganic filler (A) to the dispersion resin (C) in the insulation paste is typically 100/0.5 to 100/15, and preferably 100/1.0 to 100/6 as a mass ratio of the inorganic filler (A)/the dispersion resin (C), for example, from the standpoint of dispersibility, coating workability, and adhesion.

The insulation paste may be produced by uniformly mixing and dispersing the components described above, for example, by using a known dispersion device, such as a disperser, a paint shaker, a sand mill, a ball mill, a pebble mill, an LMZ mill, a DCP pearl mill, a planetary ball mill, a homogenizer, a twin-screw kneader, or a thin-film, spinning, high-speed mixer.

### Insulation Layer

An insulation layer (insulation film, coating film) is formed by applying the insulation paste described above to a current collector (coating a current collector with the insulation paste). The term “insulation” in the present invention means a volume resistivity of 1.0×10⁶ Ω·cm or more.

In the present invention, the “insulation layer” (insulation film, coating film) refers to a solid film formed by applying a liquid insulation paste to a substrate (charging body) and drying the coating by heating. An insulation film can be obtained by removing an insulation layer (insulation film, coating film) from a substrate, or an insulation layer (insulation film, coating film) can be obtained by applying an insulation paste to both surfaces of a plate-shaped substrate (current collector). The insulation layer (insulation film, coating film) of the present invention is preferably non-porous.

Although the current collector (substrate) is not particularly limited as long as it is metal, the current collector is preferably aluminum or a composite metal containing aluminum, optionally with the surface degreased or treated.

The method for applying the insulation paste is not particularly limited as long as the insulation paste can be applied with a film thickness within a predetermined range. The method for applying the insulation paste can be, for example, roller coating, brush coating, atomization coating, dipping coating, applicator coating, shower coat coating, roll coater coating, or die coater coating.

The thickness of the coating film is preferably 1 to 50 μm, and more preferably 2 to 20 μm, on a dry film basis. The drying temperature for the coating film is preferably 60 to 300° C., and more preferably 80 to 200° C.

The solvent contained in the insulation paste is lost by drying by heating preferably in an amount of 90 mass % or more, more preferably 95 mass % or more, and particularly preferably 99 mass % or more.

The adhesive force of the insulation layer obtained by applying the insulation paste to a current collector is preferably 2.5 N/m or more, more preferably 4.5 N/m or more, more preferably 6.5 N/m or more, and still more preferably 10 N/m or more.

An adhesive force of 2.5 N/m or more can maintain an excellent condition even if a load such as pressing, bending, or impact is applied.

The adhesive force of the insulation layer to the current collector can be measured according to the following test method.

### Method for Measuring Adhesive Force of Insulation Layer

The insulation paste is applied to a current collector with an applicator and dried at 120° C. for 30 minutes, thereby forming a coating film (dry film thickness: 15 μm).

Subsequently, a PET film with a thickness of 300 μm for reinforcement is adhered to the coating film on a test panel formed of a laminate of the current collector and the coating film with double-sided tape, and the obtained laminate is cut into strips with a length of 10 cm and a width of 1.5 cm with a cutter knife in the thickness from the PET to the coating film.

Double-sided tape is further adhered to the surface of the current collector of the sample placed horizontally, and the sample is adhesively fixed on a tin plate. A 180-degree peeling test is performed with an EZ Test tensile tester (trade name, produced by Shimadzu Corporation) at a tension rate of 10 cm/minute. With one of the two shorter sides of the sample gripped, the coating film is peeled from the current collector, and the adhesive force between the current collector and the coating film (insulation layer) is measured.

The present invention also includes the following subject matter.

### Item 1.

An insulation paste for a current collector for a lithium-ion secondary battery, comprising

an inorganic filler (A),

a binder (B),

a dispersion resin (C), and

a solvent (D),

wherein the insulation paste has a viscosity at a shear rate of 1 s⁻¹ of 1500 mPa·s or more, and has a TI value of greater than 1, the TI value being a ratio of the viscosity at a shear rate of 1 s⁻¹ to the viscosity at a shear rate of 1000 s⁻¹.

### Item 2.

The insulation paste for a current collector for a lithium-ion secondary battery according to Item 1, wherein an insulation layer obtained by applying the insulation paste to a current collector has an adhesive force of 2.5 N/m or more.

### Item 3.

The insulation paste for a current collector for a lithium-ion secondary battery according to Item 1 or 2, wherein the insulation paste has a viscosity at a shear rate of 1 s⁻¹ of 1800 mPa·s or more.

### Item 4.

The insulation paste for a current collector for a lithium-ion secondary battery according to Item 1 or 2, wherein the insulation paste has a viscosity at a shear rate of 1 s⁻¹ of 2000 mPa·s or more.

### Item 5.

The insulation paste for a current collector for a lithium-ion secondary battery according to any one of Items 1 to 4, wherein the inorganic filler (A) has a volume average particle size (D50) of 0.5 to 7 μm, and has a standard deviation of particle size distribution of 1.4 μm or less.

### Item 6.

The insulation paste for a current collector for a lithium-ion secondary battery according to any one of Items 1 to 5, wherein the dispersion resin (C) contains an acrylic resin having a polar group.

### Item 7.

The insulation paste for a current collector for a lithium-ion secondary battery according to Item 6, wherein the polar group of the acrylic resin having a polar group comprises a phosphate group.

### Item 8.

The insulation paste for a current collector for a lithium-ion secondary battery according to Item 6 or 7, wherein the acrylic resin having a polar group is a polymer of a starting material monomer containing a polymerizable unsaturated monomer having a hydrocarbon group that has four or more carbon atoms (c2).

### Item 9.

The insulation paste for a current collector for a lithium-ion secondary battery according to Item 8, wherein the starting material monomer further contains a polymerizable unsaturated monomer having a polar functional group (c1), or an additional polymerizable unsaturated monomer, other than the polymerizable unsaturated monomer having a polar functional group (c1) and the polymerizable unsaturated monomer having a hydrocarbon group that has four or more carbon atoms (c2), or both.

### Item 10.

The insulation paste for a current collector for a lithium-ion secondary battery according to Item 9, wherein the starting material monomer contains the additional polymerizable unsaturated monomer, and the additional polymerizable unsaturated monomer comprises an unsaturated monomer having an alkyl group that has 3 or fewer carbon atoms.

### Item 11.

The insulation paste for a current collector for a lithium-ion secondary battery according to any one of Items 6 to 10, wherein the acrylic resin having a polar group has a weight average molecular weight within the range of 1,000 to 100,000.

### Item 12.

The insulation paste for a current collector for a lithium-ion secondary battery according to Item 1,

wherein

the dispersion resin (C) contains an acrylic resin having a polar group (c) which is a copolymer of starting material monomers containing
a polymerizable unsaturated monomer having a polar functional group (c1), and
a polymerizable unsaturated monomer having a hydrocarbon group that has four or more carbon atoms (c2), and

the copolymer has a weight average molecular weight of 1,000 to 100,000.

### Item 13.

The insulation paste for a current collector for a lithium-ion secondary battery according to Item 9 or 12, wherein the polymerizable unsaturated monomer having a polar functional group (c1) is present in an amount of 20 to 60 mass % in the starting material monomer(s), and the polymerizable unsaturated monomer having a hydrocarbon group that has four or more carbon atoms (c2) is present in an amount of 20 to 60 mass % in the starting material monomer(s).

### Item 14.

The insulation paste for a current collector for a lithium-ion secondary battery according to any one of Items 1 to 13, wherein the inorganic filler (A) contains at least one member selected from the group consisting of alumina, silica, TiO₂, BaTiO₃, ZrO₂, boehmite, zeolite, apatite, and kaolin.

### Item 15.

The insulation paste for a current collector for a lithium-ion secondary battery according to any one of Items 1 to 14, wherein the inorganic filler (A) contains alumina and/or boehmite.

### Item 16.

The insulation paste for a current collector for a lithium-ion secondary battery according to any one of Items 1 to 15, wherein the binder (B) contains a modified or unmodified polyvinylidene fluoride.

### Item 17.

The insulation paste for a current collector for a lithium-ion secondary battery according to any one of Items 1 to 16, wherein the solvent (D) contains N-methyl-2-pyrrolidone.

### Item 18.

The insulation paste for a current collector for a lithium-ion secondary battery according to any one of Items 1 to 17, comprising substantially no active substance for an electrode.

### Item 19.

A method for producing an insulation layer for a current collector for a lithium-ion secondary battery, comprising applying the insulation paste of any one of Items 1 to 18 to partially or entirely to a current collector, and subsequently drying the paste by heating to form an insulation layer.

### Item 20.

The method for producing an insulation layer for a current collector for a lithium-ion secondary battery according to Item 19, wherein the insulation layer is non-porous.

### Item 21.

The method for producing an insulation layer for a current collector for a lithium-ion secondary battery according to Item 19 or 20, wherein the current collector contains aluminum or a composite metal containing aluminum.

### EXAMPLES

The present invention is described below in more detail with reference to Examples and Comparative Examples.

The method for synthesizing various resins, the method for producing a secondary battery, and the evaluation test method used below are methods known in the art.

However, the present invention is not limited to these Examples. Various alterations and modifications can be made within the equivalent range of the technical concept of the present invention and the claims.

In the following Examples, parts and percentages (%) are by mass.

### Test 1

### Production of Acrylic Resin

### Production Example 1A

Forty parts of N-methyl-2-pyrrolidone was placed in a reactor equipped with a stirring heater and a condenser tube. After nitrogen replacement, the reactor was maintained at 115° C. The following monomer mixture was then added dropwise over a period of 4 hours.

Monomer Mixture

| | | |
|---|---|---|
| Styrene | 30 | parts |
| n-Butyl acrylate | 20 | parts |
| Lauryl methacrylate | 15 | parts |
| Methyl methacrylate | 35 | parts |
| t-Butylperoxy-2-ethylhexanoate | 3 | parts |
| (polymerization initiator) | | |

One hour after the completion of the dropwise addition, a solution of 0.5 parts of t-butylperoxy-2-ethylhexanoate in 10 parts of N-methyl-2-pyrrolidone was added dropwise over a period of 1 hour. After completion of the dropwise addition, the resulting mixture was maintained at 115° C. for another 1 hour. Subsequently, N-methyl-2-pyrrolidone was added so as to give a solids content of 50%, thereby obtaining a solution of acrylic resin (C-1) with a solids content of 50%. Acrylic resin (C-1) had a weight average molecular weight (Mw) of 18,000.

### Production Examples 2A to 17A

Solutions of acrylic resins (C-2) to (C-17) were produced in the same manner as in Production Example 1A, except that the monomer composition was changed as shown in Table 1 below.

Table 1 shows the weight average molecular weight (Mw) of each resin.

TABLE 1

| | | | Production Example | | | | | | | | |
|---|---|---|---|---|---|---|---|---|---|---|---|
| | | | 1A | 2A | 3A | 4A | 5A | 6A | 7A | 8A | 9A |
| Acrylic Resin | | | C-1 | C-2 | C-3 | C-4 | C-5 | C-6 | C-7 | C-8 | C-9 |
| Monomer | Polymerizable | Dimethylaminoethyl | | 30 | | | | | | | |
| Mixture | Unsaturated | Methacrylate | | | | | | | | | |
| | Monomer Having | Methacrylic Acid | | | 30 | | | | | | 80 |
| | Polar Group | 2-Methacryloyl- | | | | 30 | 30 | 20 | | | |
| | (c1) | oxyethyl | | | | | | | | | |
| | | Acid Phosphate | | | | | | | | | |
| | | 2-Acrylamide-2- | | | | | | | 30 | | |
| | | Methylpropane- | | | | | | | | | |
| | | sulfonic acid | | | | | | | | | |
| | | 2-Hydroxyethyl- | | | | | 10 | 10 | | 30 | |
| | | methacrylate | | | | | | | | | |
| | Polymerizable | Styrene | 30 | 20 | 20 | 20 | 10 | 20 | 20 | 20 | 5 |
| | Unsaturated | n-Butyl | 20 | 20 | 20 | 20 | 20 | 20 | 20 | 20 | 5 |
| | Monomer Having | Acrylate | | | | | | | | | |
| | Alkyl Group | Lauryl | 15 | 10 | 10 | 10 | 10 | 10 | 10 | 10 | 5 |
| | That Has Four | Methacrylate | | | | | | | | | |
| | or More Carbon | | | | | | | | | | |
| | Atoms (c2) | | | | | | | | | | |
| | Other | Methyl | 35 | 20 | 20 | 20 | 20 | 20 | 20 | 20 | 5 |
| | Polymerizable | Methacrylate | | | | | | | | | |
| | Unsaturated | | | | | | | | | | |
| | Monomer | | | | | | | | | | |

| | | | | | | | | | |
|---|---|---|---|---|---|---|---|---|---|
| t-Butylperoxy-2-Ethylhexanoate | 3 | 3 | 3 | 3 | 3 | 3 | 3 | 3 | 3 |
| (Polymerization Initiator) | | | | | | | | | |

| | | | | | | | | | |
|---|---|---|---|---|---|---|---|---|---|
| Weight Average Molecular Weight (Mw) | 18000 | 18000 | 18000 | 20000 | 20000 | 19000 | 19000 | 18000 | 18000 |

| | | | Production Example | | | | | | | |
|---|---|---|---|---|---|---|---|---|---|---|
| | | | 10A | 11A | 12A | 13A | 14A | 15A | 16A | 17A |
| Acrylic Resin | | | C-10 | C-11 | C-12 | C-13 | C-14 | C-15 | C-16 | C-17 |
| Monomer | Polymerizable | Dimethylaminoethyl | | | | | | | | |
| Mixture | Unsaturated | Methacrylate | | | | | | | | |
| | Monomer Having | Methacrylic Acid | 3 | | | | | | | |
| | Polar Group | 2-Methacryloyl- | | 80 | 3 | 30 | 20 | 20 | 20 | 20 |
| | (c1) | oxyethyl Acid | | | | | | | | |
| | | Phosphate | | | | | | | | |
| | | 2-Acrylamide-2- | | | | | | | | |
| | | Methylpropane- | | | | | | | | |
| | | sulfonic acid | | | | | | | | |
| | | 2-Hydroxyethyl- | | | | 50 | 10 | 10 | 10 | 10 |
| | | methacrylate | | | | | | | | |
| | Polymerizable | Styrene | 20 | 5 | 20 | 5 | 15 | 15 | 0 | 5 |
| | Unsaturated | n-Butyl | 30 | 5 | 30 | 5 | 20 | 20 | 0 | 65 |
| | Monomer Having | Acrylate | | | | | | | | |
| | Alkyl Group | Lauryl | 15 | 5 | 15 | 5 | 15 | 15 | 0 | 0 |
| | That Has Four | Methacrylate | | | | | | | | |
| | or More Carbon | | | | | | | | | |
| | Atoms (c2) | | | | | | | | | |
| | Other | Methyl | 32 | 5 | 32 | 5 | 20 | 20 | 70 | 0 |
| | Polymerizable | Methacrylate | | | | | | | | |
| | Unsaturated | | | | | | | | | |
| | Monomer | | | | | | | | | |

| | | | | | | | | |
|---|---|---|---|---|---|---|---|---|
| t-Butylperoxy-2-Ethylhexanoate | 3 | 3 | 3 | 3 | 10 | 0.5 | 3 | 3 |
| (Polymerization Initiator) | | | | | | | | |

| | | | | | | | | |
|---|---|---|---|---|---|---|---|---|
| Weight Average Molecular Weight (Mw) | 18000 | 22000 | 18000 | 20000 | 3000 | 90000 | 19000 | 19000 |

### Production of Insulation Paste

### Example 1A

80 parts of boehmite (A1-1), 20 parts of polyvinylidene fluoride (PVDF) (weight average molecular weight: 500,000, unmodified), 4.8 parts of a solution of acrylic resin (C-1) (resin solids content: 2.4 parts), and 250 parts of N-methyl-2-pyrrolidone (NMP) were placed in a vessel, and the mixture was sufficiently dispersed with a planetary mixer, thereby obtaining insulation paste (X-1A). This step was performed at room temperature (about 20° C.).

### Examples 2A to 28A and Comparative Examples 1A to 3A

Insulation pastes (X-2A) to (X-31A) were produced in the same manner as in Example 1A, except that the starting material composition was changed as shown in the following Table 2.

The viscosity of the obtained insulation pastes were measured with a Mars 2 cone and plate viscometer (trade name, produced by HAAKE). Table 2 shows the measured viscosity (shear rate: 1 s⁻¹, viscosity unit: mPa·s) and the TI value (the ratio of the viscosity at a shear rate of 1s⁻¹ to the viscosity at a shear rate of 1000 s⁻¹).

An insulation layer (coating film) was also prepared according the method described later, and an evaluation test was performed on the insulation paste and insulation layer (coating film). Table 2 shows the evaluation results of adhesion, dispersibility, appearance (surface), and pigment sedimentation. If even one item fails, the insulation paste is considered fail.

In Comparative Example 1, the dispersibility failed, and the evaluation of pigment sedimentation was thus not performed.

TABLE 2

| | | | Example and Comparative Example Example | | | | | | | | |
|---|---|---|---|---|---|---|---|---|---|---|---|
| | | | 1A | 2A | 3A | 4A | 5A | 6A | 7A | 8A | 9A |
| Insulation Paste | | | X-1A | X-2A | X-3A | X-4A | X-5A | X-6A | X-7A | X-8A | X-9A |
| Composition | Filler | Boehmite | 80 | 80 | 80 | 80 | 80 | 80 | 80 | 80 | 80 |
| | | (A1-1) | | | | | | | | | |
| | | Alumina | | | | | | | | | |
| | Binder | PVDF | 20 | 20 | 20 | 20 | 20 | 20 | 20 | 20 | 20 |
| | Dispersion | Resin | C-1 | C-2 | C-3 | C-4 | C-5 | C-6 | C-7 | C-8 | C-9 |
| | Resin | Resin | 2.4 | 2.4 | 2.4 | 2.4 | 2.4 | 2.4 | 2.4 | 2.4 | 2.4 |
| | | Amount | | | | | | | | | |
| | Solvent | NMP | 250 | 250 | 250 | 250 | 250 | 250 | 250 | 250 | 250 |
| | | n-Butanol | | | | | | | | | |

| | | | | | | | | | | |
|---|---|---|---|---|---|---|---|---|---|---|
| Viscosity | Viscosity | 3000 | 3000 | 3000 | 3000 | 3000 | 3000 | 3000 | 3000 | 3000 |
| | (1s-1) | | | | | | | | | |
| | TI Value | 4.5 | 4.5 | 4.5 | 4.5 | 4.5 | 4.5 | 4.5 | 4.5 | 4.5 |

| | | | | | | | | | | |
|---|---|---|---|---|---|---|---|---|---|---|
| Evaluation | Adhesion | C | C | B | A | A | A | B | C | A |
| | Dispersibility | D | B | A | A | A | A | A | B | B |
| | Appearance (Surface) | B | A | A | A | A | A | A | A | D |
| | Pigment Sedimentation | A | A | A | A | A | A | A | A | A |

| | | | Example and Comparative Example Example | | | | | | |
|---|---|---|---|---|---|---|---|---|---|
| | | | 10A | 11A | 12A | 13A | 14A | 15A | 16A |
| Insulation Paste | | | X-10A | X-11A | X-12A | X-13A | X-14A | X-15A | X-16A |
| Composition | Filler | Boehmite | 80 | 80 | 80 | 80 | 80 | 80 | 80 |
| | | (A1-1) | | | | | | | |
| | | Alumina | | | | | | | |
| | Binder | PVDP | 20 | 20 | 20 | 20 | 20 | 20 | 20 |
| | Dispersion | Resin | C-10 | C-11 | C-12 | C-13 | C-14 | C-15 | C-16 |
| | Resin | Resin | 2.4 | 2.4 | 2.4 | 2.4 | 2.4 | 2.4 | 2.4 |
| | | Amount | | | | | | | |
| | Solvent | NMP | 250 | 250 | 250 | 250 | 250 | 250 | 250 |
| | | n-Butanol | | | | | | | |

| | | | | | | | | |
|---|---|---|---|---|---|---|---|---|
| Viscosity | Viscosity | 3000 | 3000 | 3000 | 3000 | 3000 | 3000 | 3000 |
| | (1s-1) | | | | | | | |
| | TI Value | 4.5 | 4.5 | 4.5 | 4.5 | 4.5 | 4.5 | 4.5 |

| | | | | | | | | |
|---|---|---|---|---|---|---|---|---|
| Evaluation | Adhesion | C | A | B | A | B | A | A |
| | Dispersibility | C | B | C | B | A | A | A |
| | Appearance (Surface) | B | D | B | D | A | B | C |
| | Pigment Sedimentation | A | A | A | A | A | A | A |

| | | | Example and Comparative Example | | | | | | | |
|---|---|---|---|---|---|---|---|---|---|---|
| | | | Example | | | | | | | |
| | | | 17A | 18A | 19A | 20A | 21A | 22A | 23A | 24A |
| Insulation Paste | | | X-17A | X-18A | X-19A | X-20A | X-21A | X-22A | X-23A | X-24A |
| Composition | Filler | Boehmite | 80 | 80 | | 80 | 80 | 80 | 80 | 80 |
| | | (A1-1) | | | | | | | | |
| | | Alumina | | | 80 | | | | | |
| | Binder | PVDF | 20 | 20 | 20 | 20 | 20 | 20 | 20 | 20 |
| | Dispersion | Resin | C-17 | PVA*¹ | C-4 | C-4 | C-4 | C-4 | C-4 | C-4 |
| | Resin | Resin | 2.4 | 2.4 | 2.4 | 2.4 | 2.4 | 2.4 | 2.4 | 1 |
| | | Amount | | | | | | | | |
| | Solvent | NMP | 250 | 250 | 250 | 300 | 350 | 200 | 150 | 250 |
| | | n-Butanol | | | | | | | | |

| | | | | | | | | | |
|---|---|---|---|---|---|---|---|---|---|
| Viscosity | Viscosity | 3000 | 3000 | 3000 | 2300 | 1800 | 6000 | 9000 | 4000 |
| | (1s-1) | | | | | | | | |
| | TI Value | 4.5 | 4.5 | 4.5 | 2.5 | 1.5 | 5.5 | 6.5 | 6 |

| | | | | | | | | | |
|---|---|---|---|---|---|---|---|---|---|
| Evaluation | Adhesion | A | A | A | A | A | A | A | A |
| | Dispersibility | A | B | B | A | A | C | D | C |
| | Appearance (Surface) | B | D | A | B | B | C | D | C |
| | Pigment Sedimentation | A | A | A | B | C | A | A | A |

| | | | Example and Comparative Example | | | | | | |
|---|---|---|---|---|---|---|---|---|---|
| | | | | | | | Comparative | | |
| | | | Example | | | | Example | | |
| | | | 25A | 26A | 27A | 28A | 1A | 2A | 3A |
| Insulation Paste | | | X-25A | X-26A | X-27A | X-28A | X-29A | X-30A | X-31A |
| Composition | Filler | Boehmite | 80 | 80 | 90 | 70 | 80 | 80 | 80 |
| | | (A1-1) | | | | | | | |
| | | Alumina | | | | | | | |
| | Binder | PVDF | 20 | 20 | 10 | 30 | 20 | 20 | 0 |
| | Dispersion | Resin | C-4 | C-4 | C-4 | C-4 | [symbol] | C-4 | C-4 |
| | Resin | Resin | 3.6 | 2.4 | 2.4 | 2.4 | — | 2.4 | 82.4 |
| | | Amount | | | | | | | |
| | Solvent | NMP | 250 | | 250 | 250 | 250 | 400 | 250 |
| | | n-Butanol | | 250 | | | | | |

| | | | | | | | | |
|---|---|---|---|---|---|---|---|---|
| Viscosity | Viscosity | 2500 | 4500 | 4500 | 4500 | 4000 | 1300 | 2000 |
| | (1s-1) | | | | | | | |
| | TI Value | 4 | 6 | 6 | 4 | 8 | 1 | 2 |

| | | | | | | | | |
|---|---|---|---|---|---|---|---|---|
| Evaluation | Adhesion | A | B | B | B | D | A | D |
| | Dispersibility | A | D | C | A | E | A | A |
| | Appearance (Surface) | A | C | B | B | E | B | B |
| | Pigment Sedimentation | A | A | C | A | — | D | C |

The amount of the inorganic filler, binder, and dispersion resin in Table 2 is on a solids basis.

Note 1: polyvinyl alcohol (degree of saponification: 99%, weight average molecular weight: 20000) was used as a dispersion resin.

The insulation pastes prepared in the Examples and Comparative Examples all had a water content of less than 0.8 mass %.

### Example 29A

80 parts of boehmite (A1-1), 20 parts of polyvinylidene fluoride (PVDF) (weight average molecular weight: 500,000, unmodified), 4.8 parts of a solution of acrylic resin (C-3) (resin solids content: 2.4 parts), and 250 parts of N-methyl-2-pyrrolidone (NMP) were placed in a vessel, and the mixture was sufficiently dispersed with a planetary mixer, thereby obtaining insulation paste (X-29A).

### Examples 30A to 36A

Insulation pastes (X-30A) to (X-36A) were produced in the same manner as in Example 1A, except that the starting material composition was changed as shown in the following Table 3.

The viscosity of the obtained insulation pastes was measured with a Mars 2 cone and plate viscometer (trade name, produced by HAAKE). Table 3 shows the measured viscosity (shear rate: 1 s⁻¹, viscosity unit: mPa·s) and the TI value (the ratio of the viscosity at a shear rate of 1 s⁻¹ to the viscosity at a shear rate of 1000 s⁻¹).

Table 3 also shows the sodium content in the insulation pastes. The sodium content was measured according to the method described in the present specification.

Table 3 also shows the evaluation results of storability (decrease in viscosity) evaluated according the method described later.

TABLE 3

| | | | Example | | | | | | | |
|---|---|---|---|---|---|---|---|---|---|---|
| | | | Example | | | | | | | |
| | | | 29A | 30A | 31A | 32A | 33A | 34A | 35A | 36A |
| Insulation Paste | | | X-29A | X-30A | X-31A | X-32A | X-33A | X-34A | χ-35A | X-36A |
| Composition | Filler | Boehmite | 80 | 80 | 80 | 80 | 80 | 80 | | |
| | | (A1-1) | | | | | | | | |
| | | Boehmite | | | | | | | 80 | |
| | | (A1-2) | | | | | | | | |
| | | Boehmite | | | | | | | | 80 |
| | | (A1-3) | | | | | | | | |
| | Binder | PVDF | 20 | 20 | 20 | 20 | 20 | 20 | 20 | 20 |
| | Dispersion | Resin | C-3 | C-4 | C-4 | C-4 | C-4 | C-4 | C-4 | C-4 |
| | Resin | Resin | 2.4 | 2.4 | 2.4 | 2.4 | 2.4 | 3.6 | 2.4 | 2.4 |
| | | Amount | | | | | | | | |
| | Solvent | NMP | 250 | 250 | 250 | 250 | 250 | 250 | 250 | 250 |

| Na Content in Paste (ppm) | | 115 | 115 | 170 | 280 | 370 | 110 | 230 | 450 |
|---|---|---|---|---|---|---|---|---|---|
| Viscosity | Viscosity | 3000 | 3000 | 3000 | 3000 | 3000 | 2500 | 3000 | 3000 |
| | (1s-1) | | | | | | | | |
| | TI Value | 4.5 | 4.5 | 4.5 | 4.5 | 4.5 | 4 | 4.5 | 4.5 |

| | | | | | | | | | |
|---|---|---|---|---|---|---|---|---|---|
| Evaluation | Storability | A | A | A | B | C | A | B | C |
| | (Decrease in Viscosity) | | | | | | | | |

The amount of the inorganic filler, binder, and dispersion resin in Table 3 is on a solids basis.

The sodium content of insulation pastes (X-31A) to (X-33A) was adjusted by adding sodium hydroxide to the pastes.

The insulation pastes prepared in the Examples all had a water content of less than 0.8 mass %.

The inorganic filler in Table 3 is the following.

Boehmite (A1-1): volume average particle size (D50) 1.3 μm, sodium content: 500 ppm
Boehmite (A1-2): volume average particle size (D50) 1.3 μm, sodium content: 1000 ppm
Boehmite (A1-3): volume average particle size (D50) 1.3 μm, sodium content 2000 ppm

### Evaluation Test

### Adhesion

An obtained insulation paste was applied to a current collector formed of an aluminum material with an applicator and dried at 80° C. for 60 minutes, thereby forming a coating film (dry film thickness: 20 μm). Subsequently, a PET film with a thickness of 300 μm for reinforcement was adhered to the coating film on a test panel formed of a laminate of the current collector and the coating film with double-sided tape, and the obtained laminate was cut into strips with a length of 10 cm and a width of 1 cm with a cutter knife in the thickness from the PET to the coating film. Double-sided tape was further adhered to the surface of the current collector of the strip-shaped sample placed horizontally, and the strip-shaped sample was adhesively fixed on a tin plate. A 180-degree peeling test was performed with an EZ Test tensile tester (trade name, produced by Shimadzu Corporation) at a tension rate of 10 cm/minute. With one of the two shorter sides of the sample gripped, the coating film was peeled off from the current collector. The adhesion between the current collector and the coating film (insulation layer) was evaluated according to the following criteria. A-C: pass, D: fail.

A: 10 N/m or more, excellent.
B: 3 N/m or more, and less than 10 N/m, good.
C: 1 N/m or more, and less than 3 N/m, practically acceptable level.
D: less than 1 N/m, not practical.

### Dispersibility

Dispersibility (dispersity) was evaluated in accordance with JIS K5600-2-5 according to the particle gauge theory. Specifically, paste was dropped on a particle gauge table and thinly spread with a scraper into a gauge groove. The particle size of the largest particle observed on the gauge was measured. Measurement was performed three times, and the average was determined to be the measurement value.

The dispersibility of the obtained insulation pastes was evaluated according to the following criteria. A-D: pass, E: fail.

A: The pigment is dispersed with a particle size of less than 15 μm. The dispersibility is excellent.
B: The pigment is dispersed with a particle size of 15 μm or more and less than 20 μm. The dispersibility is very good.
C: The pigment is dispersed with a particle size of 20 μm or more and less than 25 μm, but aggregates are not visually observed.
The dispersibility is average.
D: The pigment is dispersed with a particle size of 25 μm or more, but aggregates are not visually observed. The dispersibility is somewhat poor.
E: Aggregates of 50 μm are observed. The dispersibility is very poor.

### Appearance (Surface)

An obtained insulation paste was applied to a current collector formed of an aluminum material with an applicator and dried at 80° C. for 60 minutes, thereby forming a coating film (dry film thickness: 15 μm). The luster (gloss), mottling, and smoothness of the coating film of each test panel were visually observed. A-D: pass, E: fail.

A: Gloss loss is somewhat observed, but excellent finish texture.
B: Gloss loss is observed, but mottling and smoothness are good, practically acceptable level.
C: Gloss loss is observed, but mottling and smoothness are good, practically acceptable level.
D: Gloss loss and mottling are observed, but practically acceptable level due to smoothness.
E: Gloss loss and mottling are observed with poor smoothness, clearly problematic.

### Pigment Sedimentation

The obtained insulation pastes were stored at 40° C. for 60 days, and pigment sedimentation was examined. The condition after 60-day storage was evaluated according to the following criteria. A-C: pass, D: fail.

A: No change.
B: Very limited sedimentation of inorganic filler is observed; however, after the paste is stirred by hand, the paste immediately returns to the condition before storage. No problems.
C: Sedimentation of inorganic filler is observed; after the paste is stirred by hand, the paste does not return to the condition before storage. However, when the paste is stirred with a disperser, the paste returns to the condition before storage.
D: Significant sedimentation of inorganic filler is observed; after the paste is stirred with a disperser, the paste does not return to the condition before storage.

### Storability (Decrease in Viscosity)

The obtained insulation pastes were stored at 40° C. for 30 days. The viscosity before and after storage was examined, and storability (decrease in viscosity) was evaluated according to the following criteria. A-C: pass, D: fail.

The viscosity was a value at a shear rate of 1 s⁻¹ as measured with a Mars 2 cone and plate viscometer (trade name, produced by HAAKE).

Decrease in viscosity (%)=100−(viscosity after storage)/(viscosity before storage)×100

A: The decrease in viscosity is less than 7% (including the viscosity after storage equal to or more than the viscosity before storage).

B: The decrease in viscosity after storage is 7% or more and less than 30%.

C: The decrease in viscosity after storage is 30% or more and less than 50%.
D: The decrease in viscosity after storage is 50% or more.

### Test 2

### Production of Acrylic Resin

### Production Example 1B

40 parts of N-methyl-2-pyrrolidone was placed in a reactor equipped with a stirring heater and a condenser tube. After nitrogen replacement, the reactor was maintained at 115° C., and the monomer mixture below was added dropwise over a period of 4 hours.

Monomer Mixture

| | | |
|---|---|---|
| Styrene | 30 | parts |
| n-Butyl acrylate | 20 | parts |
| Lauryl methacrylate | 15 | parts |
| Methyl methacrylate | 35 | parts |
| t-Butylperoxy-2-ethylhexanoate | 3 | parts |
| (polymerization initiator) | | |

One hour after the completion of the dropwise addition, a solution of 0.5 parts of t-butylperoxy-2-ethylhexanoate in 10 parts of N-methyl-2-pyrrolidone was added dropwise over a period of 1 hour. After completion of the dropwise addition, the resulting mixture was maintained at 115° C. for another 1 hour. Subsequently, N-methyl-2-pyrrolidone was added so as to give a solids content of 50%, thereby obtaining a solution of acrylic resin (C-1) with a solids content of 50%. Acrylic resin (C-1) had a weight average molecular weight (Mw) of 18,000.

### Production Examples 2B to 17B

Solutions of acrylic resins (C-2) to (C-17) were produced in the same manner as in Production Example 1B, except that the monomer composition was changed as shown in the following Table 4.

Table 4 shows the weight average molecular weight (Mw) of each resin.

TABLE 4

| | | | Production Example | | | | | | | | |
|---|---|---|---|---|---|---|---|---|---|---|---|
| | | | 1B | 2B | 3B | 4B | 5B | 6B | 7B | 8B | 9B |
| Acrylic Resin | | | C-1 | C-2 | C-3 | C-4 | C-5 | C-6 | C-7 | C-8 | C-9 |
| Monomer | Polymerizable | Dimethylaminoethyl | | 30 | | | | | | | |
| Mixture | Unsaturated | Methacrylate | | | | | | | | | |
| | Monomer Having | Methacrylic Acid | | | 30 | | | | | | 80 |
| | Polar Group | 2-Methacryloyl- | | | | 30 | 30 | 20 | | | |
| | (c1) | oxyethyl Acid | | | | | | | | | |
| | | Phosphate | | | | | | | | | |
| | | 2-Acrylamide-2- | | | | | | | 30 | | |
| | | Methylpropane- | | | | | | | | | |
| | | sulfonic acid | | | | | | | | | |
| | | 2-Hydroxyethyl- | | | | | 10 | 10 | | 30 | |
| | | methacrylate | | | | | | | | | |
| | Polymerizable | Styrene | 30 | 20 | 20 | 20 | 10 | 20 | 20 | 20 | 5 |
| | Unsaturated | n-Butyl | 20 | 20 | 20 | 20 | 20 | 20 | 20 | 20 | 5 |
| | Monomer Having | Acrylate | | | | | | | | | |
| | Alkyl Group | Lauryl | 15 | 10 | 10 | 10 | 10 | 10 | 10 | 10 | 5 |
| | That Has Four | Methacrylate | | | | | | | | | |
| | or More Carbon | | | | | | | | | | |
| | Atoms (c2) | | | | | | | | | | |
| | Other | Methyl | 35 | 20 | 20 | 20 | 20 | 20 | 20 | 20 | 5 |
| | Polymerizable | Methacrylate | | | | | | | | | |
| | Unsaturated | | | | | | | | | | |
| | Monomer | | | | | | | | | | |

| | | | | | | | | | |
|---|---|---|---|---|---|---|---|---|---|
| t-Butylperoxy-2-Ethylhexanoate | 3 | 3 | 3 | 3 | 3 | 3 | 3 | 3 | 3 |
| (Polymerization Initiator) | | | | | | | | | |

| | | | | | | | | | |
|---|---|---|---|---|---|---|---|---|---|
| Weight Average Molecular Weight (Mw) | 18000 | 18000 | 18000 | 20000 | 20000 | 19000 | 19000 | 18000 | 18000 |

| | | | Production Example | | | | | | | |
|---|---|---|---|---|---|---|---|---|---|---|
| | | | 10B | 11B | 12B | 13B | 14B | 15B | 15B | 17B |
| Acrylic Resin | | | C-10 | C-11 | C-12 | C-13 | C-14 | C-15 | C-16 | C-17 |
| Monomer | Polymerizable | Dimethylaminoethyl | | | | | | | | |
| Mixture | Unsaturated | Methacrylate | | | | | | | | |
| | Monomer Having | Methacrylic Acid | 3 | | | | | | | |
| | Polar Group | 2-Methacryloyl- | | 80 | 3 | 30 | 20 | 20 | 20 | 20 |
| | (c1) | oxyethyl Acid | | | | | | | | |
| | | Phosphate | | | | | | | | |
| | | 2-Acrylamide-2- | | | | | | | | |
| | | Methylpropane- | | | | | | | | |
| | | sulfonic acid | | | | | | | | |
| | | 2-Hydroxyethyl- | | | | 50 | 10 | 10 | 10 | 10 |
| | | methacrylate | | | | | | | | |
| | Polymerizable | Styrene | 20 | 5 | 20 | 5 | 15 | 15 | 0 | 5 |
| | Unsaturated | n-Butyl | 30 | 5 | 30 | 5 | 20 | 20 | 0 | 65 |
| | Monomer Having | Acrylate | | | | | | | | |
| | Alkyl Group | Lauryl | 15 | 5 | 15 | 5 | 15 | 15 | 0 | 0 |
| | That Has Four | Methacrylate | | | | | | | | |
| | or More Carbon | | | | | | | | | |
| | Atoms (c2) | | | | | | | | | |
| | Other | Methyl | 32 | 5 | 32 | 5 | 20 | 20 | 70 | 0 |
| | Polymerizable | Methacrylate | | | | | | | | |
| | Unsaturated | | | | | | | | | |
| | Monomer | | | | | | | | | |

| | | | | | | | | |
|---|---|---|---|---|---|---|---|---|
| t-Butylperoxy-2-Ethylhexanoate | 3 | 3 | 3 | 3 | 10 | 0.5 | 3 | 3 |
| (Polymerization Initiator) | | | | | | | | |

| | | | | | | | | |
|---|---|---|---|---|---|---|---|---|
| Weight Average Molecular Weight (Mw) | 18000 | 22000 | 18000 | 20000 | 3000 | 90000 | 19000 | 19000 |

### Production of Insulation Paste

### Example 1B

80 parts of boehmite (A2-1), 10 parts of polyvinylidene fluoride (PVDF) (weight average molecular weight: 900,000, unmodified), 4.8 parts of a solution of acrylic resin (C-1)-(resin solids content: 2.4), and 250 parts of N-methyl-2-pyrrolidone (NMP) were placed in a vessel, and the mixture was sufficiently dispersed with a planetary mixer, thereby obtaining insulation paste (X-1B).

### Examples 2B to 27B and Comparative Examples 1B and 2B

Insulation pastes (X-2B) to (X-29B) were produced in the same manner as in Example 1B, except that the starting material composition was changed as shown in the following Table 5.

Table 5 shows the values of the adhesive force, volume average particle size (μm), and standard deviation of particle size distribution (μm) of the obtained insulation pastes. The adhesive force, volume average particle size (μm), and standard deviation of particle size distribution (μm) were measured according to the methods described in the present specification.

Table 5 also shows the evaluation results of dispersibility, pigment sedimentation, appearance, and bendability, described later. If even one item fails, the insulation paste is considered fail.

TABLE 5

| | | | Example and Comparative Example | | | | | | | | | | | | | | |
|---|---|---|---|---|---|---|---|---|---|---|---|---|---|---|---|---|---|
| | | | Example | | | | | | | | | | | | | | |
| | | | 1B | 2B | 3B | 4B | 5B | 6B | 7B | 8B | 9B | 10B | 11B | 12B | 13B | 14B | 15B |
| Insulation Paste | | | X-1B | X-2B | X-3B | X-4B | X-5B | X-6 | X-7 | X-8 | X-9 | X-10 | X-11 | X-12 | X-13 | X-14 | X-15 |
| Composition | Filler | Boehmite | 80 | 80 | 80 | 80 | 80 | 80 | 80 | 80 | 80 | 80 | 80 | 80 | 80 | 80 | 80 |
| | | (A2-1) | | | | | | | | | | | | | | | |
| | | Boehmite | | | | | | | | | | | | | | | |
| | | (A2-2) | | | | | | | | | | | | | | | |
| | | Boehmite | | | | | | | | | | | | | | | |
| | | (A2-3) | | | | | | | | | | | | | | | |
| | | Boehmite | | | | | | | | | | | | | | | |
| | | (A2-4) | | | | | | | | | | | | | | | |
| | | Alumina | | | | | | | | | | | | | | | |
| | | (A2-5) | | | | | | | | | | | | | | | |
| | Binder | PVDF | 20 | 20 | 20 | 20 | 20 | 20 | 20 | 20 | 20 | 20 | 20 | 20 | 20 | 20 | 20 |
| | Dispersion | Resin | C-1 | C-2 | C-3 | C-4 | C-5 | C-6 | C-7 | C-8 | C-9 | C-10 | C-11 | C-12 | C-13 | C-14 | C-15 |
| | Resin | Resin | 2.4 | 2.4 | 2.4 | 2.4 | 2.4 | 2.4 | 2.4 | 2.4 | 2.4 | 2.4 | 2.4 | 2.4 | 2.4 | 2.4 | 2.4 |
| | | Amount | | | | | | | | | | | | | | | |
| | Solvent | NMP | 250 | 250 | 250 | 250 | 250 | 250 | 250 | 250 | 250 | 250 | 250 | 250 | 250 | 250 | 250 |
| | | n-Butanol | | | | | | | | | | | | | | | |

| Adhesive Force | | 2.5 | 4 | 6 | 8 | 8 | 8 | 7 | 4 | 6.5 | 4 | 8 | 6 | 8 | 6 | 8 |
|---|---|---|---|---|---|---|---|---|---|---|---|---|---|---|---|---|
| Volume Average Particle Size | | 7.5 | 4.0 | 2.5 | 2.5 | 2.5 | 2.5 | 2.5 | 4.5 | 4.0 | 6.5 | 4.0 | 6.5 | 4.0 | 2.5 | 4.5 |
| (D50) (μm) | | | | | | | | | | | | | | | | |
| Standard Deviation of Particle | | 3 | 2 | 1.2 | 0.8 | 0.8 | 0.8 | 1.2 | 1.6 | 1.6 | 2.5 | 1.6 | 2.5 | 1.6 | 0.8 | 1.6 |
| Size Distribution(μm) | | | | | | | | | | | | | | | | |
| Evaluation | Dispersibility | D | B | A | A | A | A | A | B | B | C | B | C | B | A | A |
| | Pigment Sedimentation | C | A | A | A | A | A | A | A | A | B | A | B | A | A | A |
| | Appearance | B | A | A | A | A | A | A | A | D | B | D | B | D | A | B |
| | Bendability | D | C | B | A | A | A | B | C | A | C | A | B | A | B | A |

| | | | Example and Comparative Example | | | | | | | | | | | | | |
|---|---|---|---|---|---|---|---|---|---|---|---|---|---|---|---|---|
| | | | | | | | | | | | | | | | Comparative | |
| | | | Example | | | | | | | | | | | | Example | |
| | | | 16B | 17B | 18B | 19B | 20B | 21B | 22B | 23B | 24B | 25B | 26B | 27B | 1B | 2B |
| Insulation Paste | | | X-16 | X-17 | X-18 | X-19 | X-20 | X-21 | X-22 | X-23 | X-24 | X-25 | X-26 | X-27 | X-28 | X-29 |
| Composition | Filler | Boehmite | 80 | 80 | 80 | | 80 | 80 | | | | 70 | 90 | 80 | 80 | 80 |
| | | (A2-1) | | | | | | | | | | | | | | |
| | | Boehmite | | | | | | | 80 | | | | | | | |
| | | (A2-2) | | | | | | | | | | | | | | |
| | | Boehmite | | | | | | | | 80 | | | | | | |
| | | (A2-3) | | | | | | | | | | | | | | |
| | | Boehmite | | | | | | | | | 80 | | | | | |
| | | (A2-4) | | | | | | | | | | | | | | |
| | | Alumina | | | | 80 | | | | | | | | | | |
| | | (A2-5) | | | | | | | | | | | | | | |
| | Binder | PVDF | 20 | 20 | 20 | 20 | 20 | 20 | | | | 30 | 10 | 20 | 20 | 0 |
| | Dispersion | Resin | C-16 | C-17 | PVA*¹ | C-4 | C-4 | C-4 | C-4 | C-4 | C-4 | C-4 | C-4 | C-4 | — | C-4 |
| | Resin | Resin | 2.4 | 2.4 | 2.4 | 2.4 | 1 | 3.6 | 2.4 | 2.4 | 2.4 | 2.4 | 2.4 | 2.4 | — | 82.4 |
| | | Amount | | | | | | | | | | | | | | |
| | Solvent | NMP | 250 | 250 | 250 | 250 | 250 | 250 | 250 | 250 | 250 | 250 | 250 | | 250 | 250 |
| | | n-Butanol | | | | | | | | | | | | 250 | | |

| Adhesive Force | | 8 | 8 | 5 | 8 | 4 | 8.5 | 4 | 6 | 8 | 8 | 2.5 | 5 | 2 | 1.5 |
|---|---|---|---|---|---|---|---|---|---|---|---|---|---|---|---|
| Volume Average Particle Size | | 4.5 | 4.5 | 3.0 | 3.0 | 6.0 | 2.5 | 0.7 | 1 | 6.5 | 2.5 | 6 | 7.5 | 8.5 | 2.5 |
| (D50) (μm) | | | | | | | | | | | | | | | |
| Standard Deviation of Particle | | 1.6 | 1.6 | 1.5 | 1 | 2.5 | 0.8 | 0.6 | 1 | 0.8 | 0.8 | 1.6 | 2.5 | 3 | 0.6 |
| Size Distribution(μm) | | | | | | | | | | | | | | | |
| Evaluation | Dispersibility | B | B | B | B | C | A | A | A | C | A | C | D | E | A |
| | Pigment Sedimentation | A | A | A | A | B | A | A | A | B | A | D | C | E | D |
| | Appearance | C | B | D | A | C | A | A | A | B | B | B | D | E | B |
| | Bendability | A | A | B | A | D | A | D | B | A | B | B | D | E | E |

The amount of the inorganic filler, binder, and dispersion resin in Table 5 is on a solids basis.

Note 1: In Example 18B, polyvinyl alcohol (degree of saponification: 99%, weight average molecular weight: 20000, solids content: 100%) was used as a dispersion resin.

The inorganic filler in Table 5 is the following.

Boehmite (A2-1): volume average particle size (D50) 1.3 μm
Boehmite (A2-2): volume average particle size (D50) 0.5 μm
Boehmite (A2-3): volume average particle size (D50) 0.8 μm
Boehmite (A2-4): volume average particle size (D50) 1.9 μm
Alumina (A2-5): volume average particle size (D50) 1.2 μm

The insulation pastes prepared in the Examples and Comparative Examples all had a water content of less than 0.8 mass %.

### Evaluation Test

### Dispersibility

The dispersibility of the obtained insulation pastes was evaluated according to the following criteria. A-D: pass, E: fail.

A: The pigment is dispersed with a particle size of less than 15 μm. The dispersibility is excellent.
B: The pigment is dispersed with a particle size of 15 μm or more and less than 20 μm. The dispersibility is very good.
C: The pigment is dispersed with a particle size of 20 μm or more and less than 25 μm, but aggregates are not visually observed.
The dispersibility is average.
D: The pigment is dispersed with a particle size of 25 μm or more, but aggregates are not visually observed. The dispersibility is somewhat poor.
E: Aggregates of 50 μm are observed. The dispersibility is very poor.

### Pigment Sedimentation

The obtained insulation pastes were stored at 40° C. for 60 days, and pigment sedimentation was examined. The condition after 60-day storage was evaluated according to the following criteria. A-D: pass, E: fail.

A: No change.
B: Very limited sedimentation of inorganic filler is observed; however, after the paste is stirred by hand, the paste immediately returns to the condition before storage. No problems.
C: Limited sedimentation of inorganic filler is observed; however, after the paste is intensely stirred by hand, the paste returns to the condition before storage.
D: Sedimentation of inorganic filler is observed. After the paste is stirred by hand, the paste does not return to the condition before storage. However, when the paste is stirred with a disperser, the paste returns to the condition before storage.
E: Significant sedimentation of inorganic filler is observed; after the paste is stirred with a disperser, the paste does not return to the condition before storage.

### Appearance

An obtained insulation paste was applied to a current collector formed of an aluminum material with an applicator and dried at 80° C. for 60 minutes, thereby forming a coating film (dry film thickness: 15 μm). The luster (gloss), mottling, and smoothness of the coating film of each test panel were visually observed. A-D: pass, E: fail.

A: Gloss loss is somewhat observed, but excellent finish texture.
B: Gloss loss is observed, but mottling and smoothness are good, practically acceptable level.
C: Gloss loss is observed, but mottling and smoothness are good, practically acceptable level.
D: Gloss loss and mottling are observed, but practically acceptable level due to smoothness.
E: Gloss loss and mottling are observed with poor smoothness, clearly problematic.

### Bendability

An obtained insulation paste was applied to a current collector formed of an aluminum material with a thickness of 1 mm with an applicator and dried at 80° C. for 60 minutes, thereby forming a coating film (dry film thickness: 20 μm). Subsequently, the coated plate was bent (with the coating film outer side) at 180 degrees, and the condition of the bent coating film was visually observed, followed by performing evaluation according to the following criteria. A-D: pass, E: fail.

A: The condition of the coating film is normal and excellent.
B: The coating film has a crack of less than 2 mm, but the substrate is not exposed.
C: The coating film has a crack of 2 mm or more and less than 10 mm, but the substrate is not exposed.
D: The coating film has a crack of 10 mm or more, and the substrate is slightly exposed.
E: The coating film is peeled off with a crack, and the substrate is exposed.

1. An insulation paste for a current collector for a lithium-ion secondary battery, comprising
an inorganic filler (A),
a binder (B),
a dispersion resin (C), and
a solvent (D),
wherein the insulation paste has a viscosity at a shear rate of 1 s⁻¹ of 1500 mPa·s or more, and has a TI value of greater than 1, the TI value being a ratio of the viscosity at a shear rate of 1 s⁻¹ to the viscosity at a shear rate of 1000 s⁻¹.

2. The insulation paste for a current collector for a lithium-ion secondary battery according to claim 1, wherein an insulation layer obtained by applying the insulation paste to a current collector has an adhesive force of 2.5 N/m or more.

3. The insulation paste for a current collector for a lithium-ion secondary battery according to claim 1, wherein the inorganic filler (A) has a volume average particle size (D50) of 0.5 to 7 μm, and has a standard deviation of particle size distribution of 1.4 μm or less.

4. The insulation paste for a current collector for a lithium-ion secondary battery according to claim 1, wherein the dispersion resin (C) contains an acrylic resin having a polar group.

5. The insulation paste for a current collector for a lithium-ion secondary battery according to claim 4, wherein the polar group of the acrylic resin having a polar group comprises a phosphate group.

6. The insulation paste for a current collector for a lithium-ion secondary battery according to claim 4, wherein the acrylic resin having a polar group is a polymer of a starting material monomer containing a polymerizable unsaturated monomer having a hydrocarbon group that has four or more carbon atoms (c2).

7. The insulation paste for a current collector for a lithium-ion secondary battery according to claim 4, wherein the acrylic resin having a polar group has a weight average molecular weight within the range of 1,000 to 100,000.

8. The insulation paste for a current collector for a lithium-ion secondary battery according to claim 1,
wherein
the dispersion resin (C) comprises an acrylic resin having a polar group (c) which is a copolymer of starting material monomers containing
a polymerizable unsaturated monomer having a polar functional group (c1), and
a polymerizable unsaturated monomer having a hydrocarbon group that has four or more carbon atoms (c2), and
the copolymer has a weight average molecular weight of 1,000 to 100,000.

9. The insulation paste for a current collector for a lithium-ion secondary battery according to claim 1, wherein the inorganic filler (A) contains at least one member selected from the group consisting of alumina, silica, TiO₂, BaTiO₃, ZrO₂, boehmite, zeolite, apatite, and kaolin.

10. The insulation paste for a current collector for a lithium-ion secondary battery according to claim 1, wherein the binder (B) contains a modified or unmodified polyvinylidene fluoride.

11. The insulation paste for a current collector for a lithium-ion secondary battery according to claim 1, wherein the solvent (D) contains N-methyl-2-pyrrolidone.

12. The insulation paste for a current collector for a lithium-ion secondary battery according to claim 11, comprising substantially no active substance for an electrode.

13. method for producing an insulation layer for a current collector for a lithium-ion secondary battery, comprising applying the insulation paste of claim 1 to partially or entirely to a current collector, and subsequently drying the paste by heating to form an insulation layer.

14. The method for producing an insulation layer for a current collector for a lithium-ion secondary battery according to claim 13, wherein the insulation layer is non-porous.

15. The method for producing an insulation layer for a current collector for a lithium-ion secondary battery according to claim 13, wherein the current collector contains aluminum or a composite metal containing aluminum.
